(19) United States
(12) Patent Application Publication
(10) Pub. No.: US 2026/0299129 A1
(43) Pub. Date: Oct. 1, 2026

(54) SYSTEM FOR DETERMINING THE VOLUME AND THE FREE FLOOR AREA IN A LOADING ZONE AND CORRESPONDING CONTROL METHOD

(71) Applicant: INNOVACTION TECHNOLOGIES, EPERCIEUX ST PAUL (FR)

(72) Inventors: Srecko SAJNOVIC, ROANNE (FR); Hugo THOMAS, FEURS (FR)

(21) Appl. No.: 18/880,228

(22) PCT Filed: Jun. 20, 2023
(86) PCT No.: PCT/FR2023/050917

§ 371 Date: Dec. 30, 2024

(30) Foreign Application Priority Data
Jun. 30, 2022 (FR) FR2206661

(51) Int. Cl. G01S 17/88; G01B 11/06; G01B 11/22; G01S 7/481

(52) U.S. Cl. CPC G01S 17/88; G01B 11/0608; G01B 11/22; G01S 7/4817

(57) ABSTRACT

A system for determining the free floor area of a loading zone. The system includes drive means, communication means, processing means and a moving beam on which height sensors are arranged that are directed towards the floor of the loading zone at normal incidence and aligned with one another at a constant height from said floor. The moving beam being designed so as to extend in a first direction above the loading zone and being configured so as to move over the loading zone when driven by the drive means in a second direction. The processing means being configured to determine the free floor area of the loading zone according to the data received from the height sensors via the communication means.

### CROSS-REFERENCE TO RELATED APPLICATIONS

This application claims priority under 35 U.S.C. § 119(a) to French Patent Application No. FR 2206661 filed on Jun. 30, 2022, and to International Patent Application No. PCT/EP2023/050917 filed in on Jun. 20, 2023, the entire contents of which are hereby incorporated by reference in their entireties for all purposes.

### TECHNICAL FIELD

The technical field of the invention is the measurement of the filling of a loading zone, and more particularly the measurement of the filling of a bed or trailer of a truck or the holds of a ship.

### BACKGROUND

Documents EP 3534332 and US 2017/0228885 are known from the prior art disclosing the measurement of the volume of cargo transiting on a loading dock or through the entrance of a truck trailer depending on a measurement of the cargoes entering the trailer and the cargoes leaving the trailer.

The determination of the volume occupied in the trailer does not determine the available floor area. However, it is the available floor area that makes it possible to determine whether new cargoes can be added to the trailer. Indeed, new cargoes, particularly in the form of pallets, cannot be arranged on cargoes already present in the trailer. Additions can therefore only be made on a part of the floor free of cargoes.

Moreover, cargoes loaded in a trailer may have different shapes and heights. Methods with acquisition devices arranged at fixed locations do not make it possible to determine the available floor area due to shading and masking effects between cargoes of different shapes. The acquisition devices are generally optical cameras or LIDARs (acronym for LIght Detection And Ranging) in three dimensions having the common point of having a wide aperture angle.

No device exists for reliably and systematically determining the floor area in a trailer.

Document US2014244098 also discloses the measurement of the volume of a truck bed depending on the measurement of the mass added in the vehicle divided by the density of the added materials.

Although such a method is suitable for homogeneous loads, this is no longer the case as soon as the materials added to the bed are heterogeneous. This is particularly the case in mining operations, for example for mixtures of soil and minerals.

Moreover, filling a bed is usually the result of a decision by the operator in charge of the loading, when it comes to the amount of material to be added. The estimation of the total mass carried by means of an average density only makes it possible to detect overloads of the truck in relation to the permissible gross vehicle weight. It does not make it possible to optimise the filling of the bed, particularly for the least dense cargoes.

No device exists for reliably and systematically determining the volume available in a bed or trailer.

### SUMMARY

The object of the invention is a system for determining the free floor area of a loading zone, comprising drive means, communication means, processing means and a moving beam on which height sensors are arranged that are directed towards the floor of the loading zone according to a normal incidence and aligned with one another at a constant height from said floor, the moving beam being designed so as to extend in a first direction above the loading zone and being configured so as to move over the loading zone under the action of the drive means in a second direction, the processing means being configured to determine the free floor area of the loading zone depending on the data received from the height sensors by means of the communication means.

The moving beam may be provided with at least one depth sensor, powered by the power supply means, and configured to determine the distance to the opposite side of the loading zone, the communication means comprise a connection to each depth sensor.

The communication means may comprise a wireless connection with a local data storage means arranged on the moving beam and connected to the height sensors and, when present, to the depth sensors, so as to transmit the data acquired by the sensors when the moving beam has finished scanning the loading zone.

The height sensors and the depth sensors may be distance sensors with a small aperture angle, preferably LIDARs.

The drive means may comprise at least two ropes each running along an end pulley, towards a tension pulley by means of an angle return pulley, the second rope being crossed by means of an intermediate pulley, the two ropes being set in motion by means of a drive roller rotated by a drive means.

The determination system may be provided with power supply means, may comprise a battery supplying power to the drive means, the communication means and the processing means, a local battery arranged on the moving beam and a contactless power transmission system configured to recharge the local battery of the moving beam, a local battery being configured to supply power to the height sensors as well as the depth sensors when the determination system is provided with it.

The loading zone may be located in a truck, in a truck bed, in a truck trailer, in a ship, in a railway car, in an aircraft, or in a building.

Another object of the invention is a method for controlling a determination system as described above, comprising the following steps:
Controlling the height sensors so as to acquire measurements,
Dating each measurement received according to an internal clock,
Controlling the drive means so that the beam starts to move and the start time of movement of the ramp is stored,
among the received measurements, determining those whose date is between the start date of movement of the beam and the end date of movement of the beam equal to the sum of the start date of movement of the beam and the duration of movement of the beam,
for each measurement of a height sensor, defining a longitudinal coordinate as the longitudinal position of the sensor at the time of the measurement, the transverse coordinate being defined as the distance between the height sensor whose measurement is processed and the first height sensor of the beam, the height coordinate being defined as the difference between the ceiling height of the trailer minus the height measurement of the height sensor,
Determining the free floor area in the loading zone, and at least one of the free volume in the loading zone, the occupied floor area in the loading zone, the occupied volume in the loading zone, along with determining a mapping of the free floor area as an image depending on the points whose height coordinate is less than a predetermined threshold or determining a mapping of the occupied floor area as an image depending on the points whose height coordinate is greater than said predetermined threshold.

The longitudinal position of a sensor at a stored date can be determined as the average moving speed of the beam multiplied by the difference between the stored date and the start date of movement of the beam.

At least one depth sensor can be controlled so as to acquire measurements and the longitudinal position of a sensor is determined depending on the distance measurement of a first depth sensor directed towards a side of the loading zone normal to the direction of movement of the moving beam.

The start time of movement of the sensor beam can be determined as the time at which the power supply means are controlled in order to power the drive means.

The measurement acquisition of a current sensor configured so as to measure the power supply current of the drive means can be controlled, and the start time of movement of the sensor beam is determined when the power supply current of the drive means exceeds a predetermined current threshold.

For packaged cargoes, an elementary area can be associated with each point whose height coordinate is less than the predetermined threshold, the elementary area being equal to the product of the distance between two height sensors in a first direction normal to the movement of the moving beam and the distance between two successive measurements in a second direction colinear to the movement of the moving beam, then the available floor area can be determined by adding up the elementary areas, and the available volume can be determined by multiplying the height of the loading zone.

For packaged cargoes, an elementary area including a plurality of measurement points can be determined, measurements are averaged over each elementary area, the elementary areas for which the average height coordinate is less than the predetermined threshold are determined, then the available floor area can be determined by adding up the elementary areas for which the average height coordinate is less than the predetermined threshold, and the available volume can be determined by multiplying the available floor area by the height of the loading zone.

The predetermined threshold may be defined as less than a minimum cargo size.

For bulk cargoes, the available volume can be determined as the volume of the loading zone minus the volume occupied by the determined cargo by integrating the height sensor measurements in the first direction and in the second direction.

An occupied floor area or occupied volume may be determined depending on measurement points whose height coordinate is greater than the predetermined threshold.

By measuring the height at normal incidence with respect to the floor of a truck trailer, the determination system makes it possible to overcome the deficiencies of the prior art and making it possible to determine both the floor area available in a truck trailer or in the cargo hold of a merchant ship and the volume available in a truck bed or in a bulk hold of a merchant ship.

### BRIEF DESCRIPTION OF THE DRAWINGS

Other aims, features and advantages of the invention will appear upon reading the following description, given solely as a non-limiting example and made with reference to the appended drawings wherein:

FIG. 1 illustrates the main elements of a determination system according to the invention,

FIG. 2 and FIG. 4 illustrate a longitudinal sectional view of a trailer when loading pallets,

FIG. 3 illustrates a top sectional view of a truck trailer illustrating the layout of the loading zone,

FIG. 5 and FIG. 6 illustrate the floor area and available volume measurement for packaged cargoes,

FIG. 7 and FIG. 8 illustrate the available volume measurement for bulk cargoes,

FIG. 9 illustrates the layout of a mathematical reference for determining the free floor area and volume of a loading zone,

FIG. 10 illustrates the main steps of a control method according to the invention,

FIG. 11 illustrates the result of the determination of the free floor area in a trailer.

### DETAILED DESCRIPTION

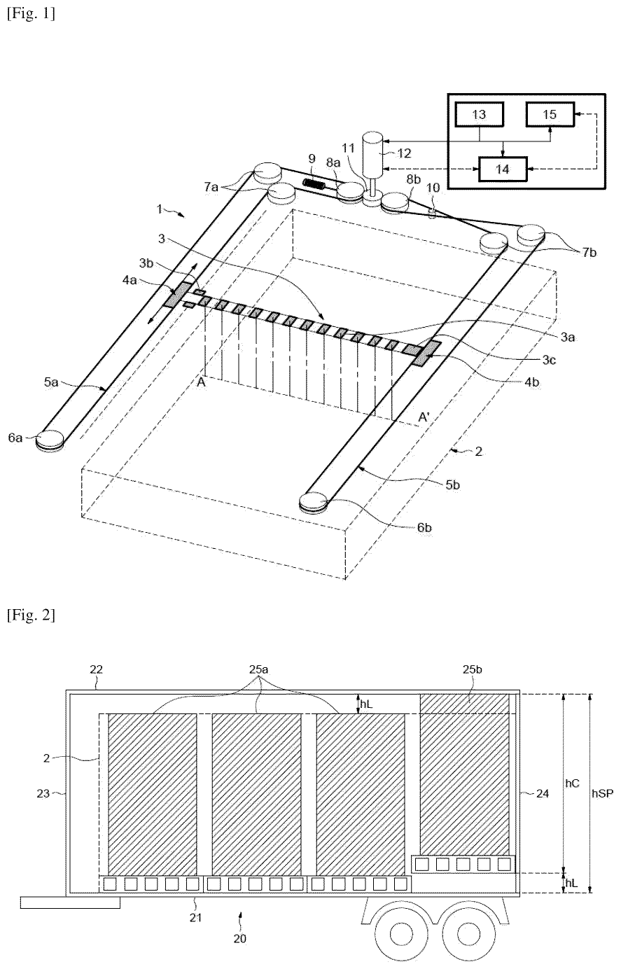

The system for determining the floor area or available volume in a loading zone, when such a loading zone is located in a trailer, is illustrated in [FIG. 1].

A loading zone is defined as the volume into which packaged or bulk cargoes can be added or removed. Generally, a loading zone has a parallelepiped shape defined by a floor, two opposite sides, two sides adjacent to the opposite sides, and a ceiling. It will be understood, however, that the invention is not limited to a parallelepipedal loading zone, so that other shapes can be taken into account, particularly cylindrical, pyramidal, prismatic, etc. Discrete shapes comprising lockers can also be analyzed by the determination system.

The determination system 1, positioned above and around a loading zone 2, comprises a moving beam 3 on which height sensors 3a are arranged, connected by each of the ends thereof to a cursor 4a, 4b. In one embodiment, the moving beam 3 also comprises depth sensors 3b. The height sensors 3a and the depth sensors 3b are distance sensors with a small aperture angle, preferably LIDARs.

The height sensors 3a are arranged so as to be directed towards the floor of the loading zone (the floor of the trailer) according to a normal incidence, while being aligned with one another and at a constant height from the floor of the loading zone. Such a layout makes it possible to limit the effects of shading or masking by loaded cargoes.

The depth sensors 3b are arranged so that at least one is directed towards one side of the loading zone normal to the direction of movement of the moving beam (the bottom of the trailer), at least one other is directed towards the opposite side of the loading zone normal to the direction of movement of the moving beam (the doors of the trailer), the direction of the depth sensors 3b being normal to the direction of movement of the moving beam and, by construction, towards the trailer bottom. In a particular case, such an assembly of at least one depth sensor 3b directed in one direction and at least one depth sensor 3b directed in an opposite direction is arranged on each side of the sensor beam 3, as close as possible to the cursors 4a, 4b.

The sensors 3a, 3b are electrically powered by a local battery 3c.

Each cursor 4a, 4b is designed so as to support the moving beam 3 and to move in a track (not illustrated). Each cursor 4a, 4b is driven in motion by a rope 5a, 5b contained in a track. The determination system 1 thus constituted is contained in a reduced vertical volume, delimited by the tracks.

The determination system 1 comprises drive means for moving the ropes 5a, 5b in order to move the moving beam 3 towards a first side of the loading zone, normal to the direction of movement of the moving beam or towards the opposite side. In the case of a trailer, the first side is close to the trailer bottom, the opposite side is next to the trailer doors. Each rope 5a, 5b runs along an end pulley 6a, 6b, towards a tension pulley 8a, 8b by means of an angle return pulley 7a, 7b.

The first tension pulley 8a is connected to a spring 9 exerting on the pulley a force contrary to the traction force resulting from the tension of the rope. The first rope 5a is thus held taut.

The second rope 5b for its part is crossed by means of an intermediate pulley 10 before running along the tension pulley 8b. The second tension pulley 8b is also connected to a spring (not illustrated) like the first tension pulley 8a.

A drive roller 11 connected to a controlled drive means 12, particularly an electric motor, is arranged between the first rope 5a and the second rope 5b at the level of the first and second drive pulleys 8a, 8b respectively so as to simultaneously drive the two ropes by contact. Other devices could be used, particularly a direct drive of the drive pulleys 8a, 8b. A clutch release device (not illustrated) is also present and makes it possible to pull the drive pulleys 8a, 8b apart in order to break contact with the drive roller 11, particularly during maintenance operations.

The determination system comprises an electronic control unit provided with power supply means 13, communication means 14 and processing means 15.

The power supply means 13 make it possible to supply power to the drive means 12 and the local battery 3c of the beam 3. This is generally a battery and switching means controlled by the processing means 15 and connected to the drive means 12 directly or by means of a voltage or power regulator. In certain particular applications, a generator may also be provided for recharging the battery, particularly photovoltaic cells or a regenerative braking system at the axles of the trailer. The generator may also be a battery or an alternator arranged in the vehicle comprising the loading zone or towing a trailer comprising the loading zone.

In one embodiment, the power supply means 13 are also provided with a contactless electric power transmission system, particularly an inductive charging system, so as to be able to charge the local battery 3c supplying power to the sensors 3a, 3b of the sensor beam 3, when the drive means are stopped. The beam 3 is then of simpler design because it is not necessary to provide a power supply cable and means for guiding said power supply cable during the movement of the beam 3.

The communication means 14 are supplied by the power supply means 13 and connected to each sensor 3a, 3b as well as to the power supply means 13. The connection with the sensors 3a, 3b is a wired or wireless connection, preferably Wi-Fi, Bluetooth, etc. As for the contactless electric power transmission system, a wireless connection makes a simpler design of the beam 3 possible because it is not necessary to provide data connection cables and means for guiding said data connection cable during the movement of the beam 3. In the particular case of a wireless connection, the communication means 14 comprise a local data storage means arranged on the moving beam 3 and by means of which the data from the sensors 3a, 3b pass. The local data storage means stores the data acquired by the sensors 3a, 3b until the moving beam has completed scanning of the loading zone. The stored data are then transmitted to the processing means 15.

The connection with the power supply means 13 make it possible to transmit commands to the power supply of the drive means 12 from the processing means 15 and/or to transmit the measurements of the power supply current of the drive means 12 to the processing means 15.

The communication means 14 also comprise a connection to a mobile telephone network or a satellite telephone network for transmitting the free floor area or the free volume.

The processing means 15, such as a processor associated with the memory, are connected to the communication means 14 by a data connection, in particular a CAN data bus, and are electrically powered by the power supply means 13.

In the particular case of truck trailers, the trailer is loaded either by pallet truck or by forklift truck. These machines make it possible to lift the pallets in order to move them and load them. As a result, the pallets loaded into the trailer have a height limited to the ceiling height of the trailer minus the lifting height. The lifting height is usually 10 cm. However, other heights can be envisaged.

[FIG. 2] illustrates a sectional view of a trailer when loading cargoes on pallets. The trailer 20 comprises a floor 21, a ceiling 22, a trailer bottom 23 and doors 24. [FIG. 2] also illustrates loaded pallet cargoes 25a and pallet cargoes 25b being loaded. The lifting equipment for lifting the cargo on a pallet 25b is not shown for reasons of clarity.

[FIG. 2] clearly illustrates that the cargo limit height hC is equal to the trailer ceiling height hSP minus the lifting height hL. Once the cargoes have been loaded, a free space of a height at least equal to the limit height hL is thus found above each loaded cargo 25a. In other words, the loading zone 2 has a height equal to the cargo limit height hC when the cargo is arranged on the floor of the loading zone.

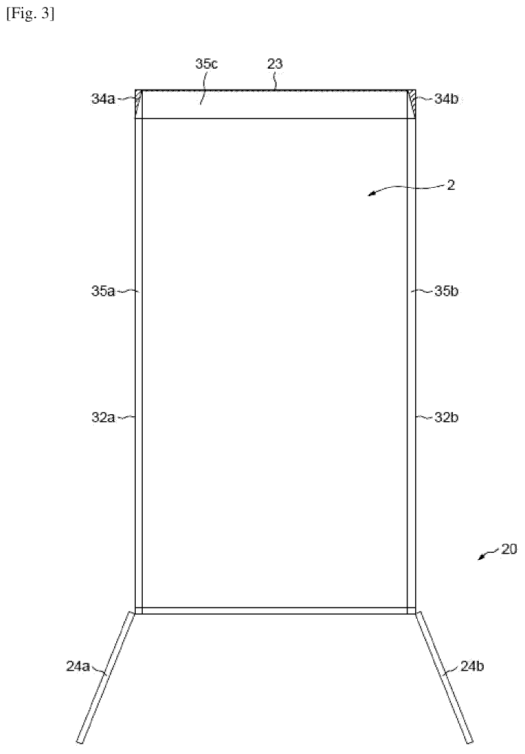

Thanks to the reduced vertical volume required by the determination system 1, it is then possible to arrange the determination system in contact with the ceiling of the trailer in the free space available above each cargo.

[FIG. 3] illustrates a top sectional view of a truck trailer 20, comprising two doors 24a, 24b, two side walls 32a, 32b and a back wall 23.

A trailer 20 has a generally parallelepipedal shape. Nevertheless, close to the trailer bottom wall 23, the trailer has a prismatic shape resulting from the subtraction of triangular base zones 34a, 34b. Such a prismatic shape is used and the triangular base zones 34a, 34b are subtracted in order to preserve the turning radius of the tractor pulling the trailer. In fact, the tractor is generally arranged as close as possible to the trailer bottom in order to gain compactness, aerodynamics and in order to facilitate the connection of the electric and pneumatic cables between the tractor and the trailer.

It follows from this shape of the trailer bottom that the area useful for loading cargoes, defined above as the loading zone, is restricted with respect to the floor area of the trailer. The loading zone 2 is limited in depth at the level of the trailer bottom wall by the depth of the triangular base zones 34a, 34b, and at the level of the doors 24a, 24b by the thickness of the doors. The loading zone 2 is limited in width on each side by the width of each of the triangular base zones 34a, 34b.

A free area is then defined equal to the area of the trailer minus the area of the loading zone, comprising a first area 35a in contact with a first lateral wall 32a, a second area 35b in contact with a second lateral wall 32b and a third area 35c in contact with the trailer bottom 23.

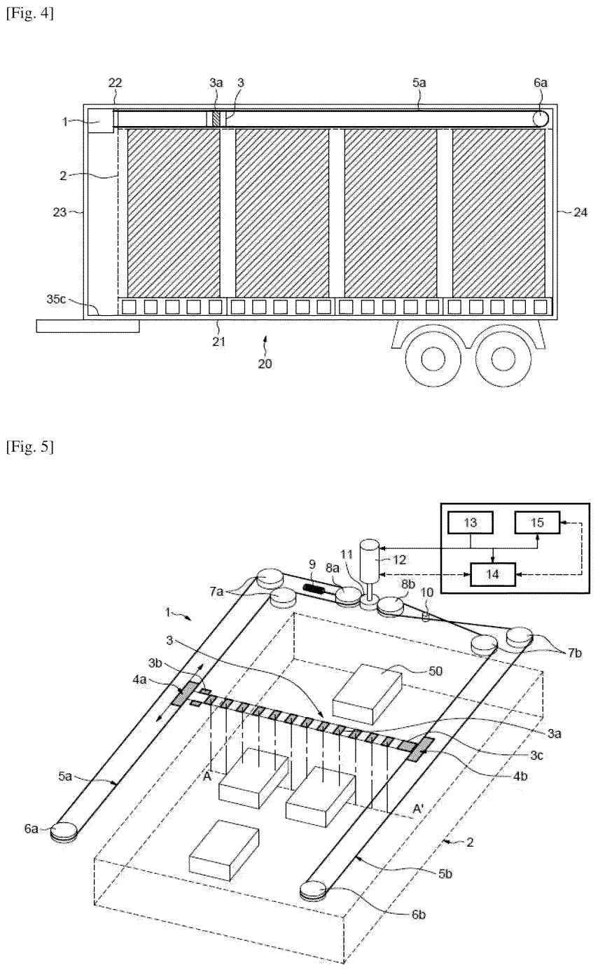

In light of [FIG. 3], it will be understood that the depth sensors 3b are preferably arranged as close as possible to the cursors 4a, 4b but facing the wall 23 of the trailer bottom arranged between the two triangular base zones 34a, 34b. Such a layout makes it possible not to have to reprocess the measurements of the depth sensors 3b in order to compensate for the difference in depth between the measurement point on the truncated area between the trailer bottom wall 23 and the lateral walls 32a, 32b.

[FIG. 4] is identical in all respects to [FIG. 2] but also illustrates the free space at the bottom of the trailer corresponding to the third free area 35c in [FIG. 3].

The determination system 1 is arranged in the free volume extending in a direction normal to the free area of the trailer up to the ceiling of the trailer. The tracks and the pulleys 6a, 6b, 7a, 7b being located in the volumes corresponding to the first and second areas 35a, 35b, the drive means 8a, 8b, 9, 10, 11, 12, the power supply means 13, the communication means 14, the processing means 15 and the moving beam 3 at rest (that is to say when no measurement is carried out) being arranged in the free volume corresponding to the third area 35c. In other words, the determination system 1 is arranged in the free volume extending on either side of the loading zone while remaining within the height of the loading zone.

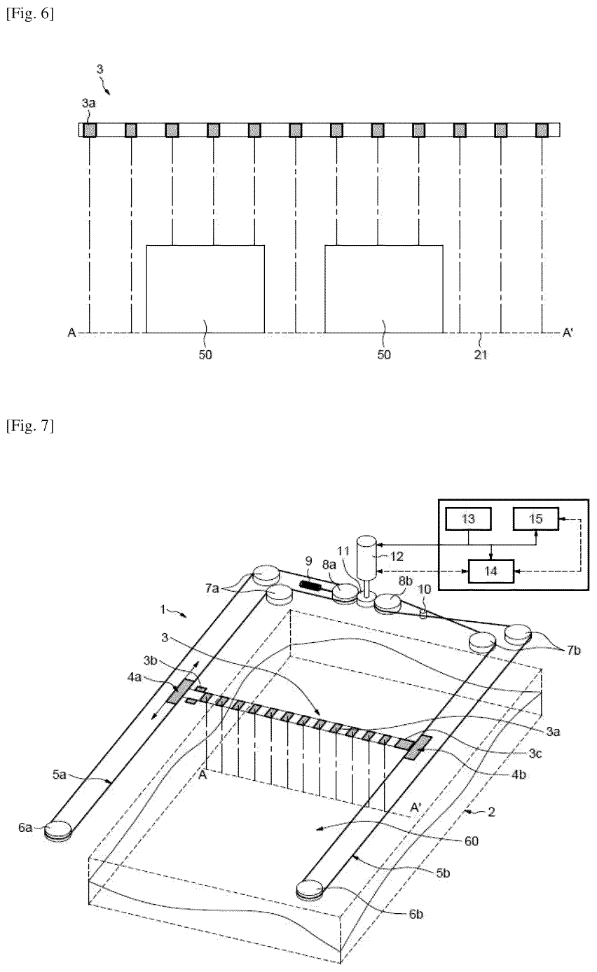

During the measurement, each height sensor 3a measures the distance between the sensor beam 3 and either a packaged cargo 50, or the bulk cargo 60, or the floor 21 of the loading zone. It will be understood that other forms of packaging can be taken into account instead of a pallet. Examples will include cans, cartons, etc.

[FIG. 5] and [FIG. 6] illustrate the measurement of the floor area and available volume for packaged cargoes, such as pallets, cans or cartons.

The beam 3 is moved along the length of the loading zone while the height sensors 3a acquire values. The measured heights depend on the presence or absence of cargo 50, 60, and when cargo 50, 60 is present, on the height thereof.

The available floor area is determined by comparing the measured points with a predetermined threshold.

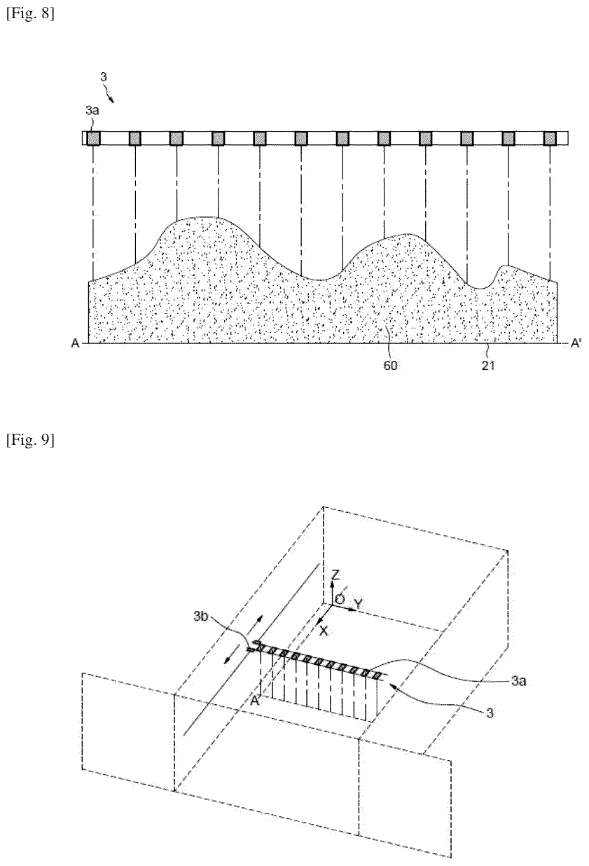

The available volume is then determined by multiplying the available floor area by the cargo limit height hC defined in [FIG. 2].

[FIG. 7] and [FIG. 8] illustrate the measurement of the available volume for bulk cargoes.

The beam 3 is moved along the length of the loading zone while the height sensors 3a acquire values. The measured heights depend on the quantity of cargo at each measuring point.

For such cargoes, the determination of available floor area is not relevant. The occupied volume is then determined directly, by integrating the height measured according to the width and length of the loading zone. An integration along the width of the loading zone is illustrated in [FIG. 8]. The available volume is then determined by the difference between the total loading zone volume and the determined occupied volume.

In [FIG. 7], it will be understood that the area of the bulk cargo varies more or less between each measurement step, depending on the nature of the cargo. Sand will tend to have smaller differences in level than rocks.

As a preamble to the presentation of the main steps of the control process, a reference (O, x, y, z) is defined, in which the origin O is fixed in the left corner at the junction between the floor and two adjacent sides of the loading zone. In a trailer, such a reference implies that the plane (O, x, z) comprises the first height sensor 3a of the beam 3. [FIG. 9] illustrates such a reference. The longitudinal direction x is colinear to the length of the trailer, increasing from the trailer bottom to the trailer doors. The transverse direction Y is colinear to the width of the trailer, increasing from left to right. The z-direction of height is colinear to the height of the trailer, increasing from the floor to the ceiling. Another reference could be chosen. Nevertheless, the reference described above makes it possible to simplify the calculations described below in the case of scanning of the loading zone in the direction of increasing longitudinal coordinates and an increasing identification of the height sensors 3a in the direction of increasing transverse coordinates. The reference described must be adapted or the calculations changed if a different movement is considered or if a different identification of the height sensors 3a is envisaged.

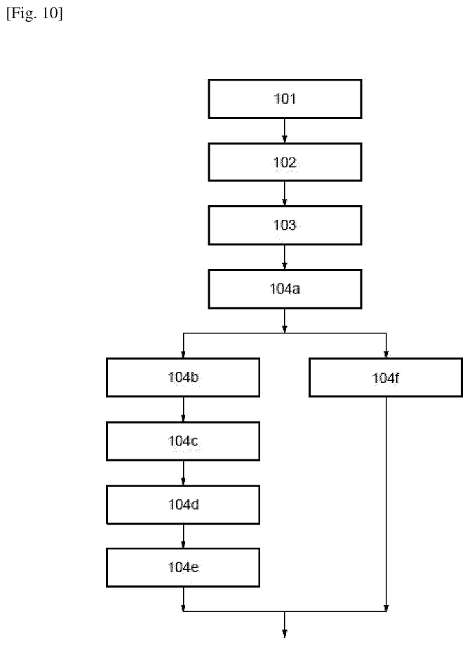

These determinations will now be specified in the context of the description of the control method, comprising the steps illustrated by FIG. 10.

The method for controlling the determination system 1 is stored in at least one memory of the processing means 15, and executed by the processor of the processing means 15.

During a first step 101, the height sensors 3a and the depth sensors 3b are controlled so as to acquire measurements. Each height sensor 3a and each depth sensor 3b is provided with a housing in which a lens or an aperture is provided according to the measurement technique used. The height or depth measurement is then carried out normal to the area of the housing through the lens or aperture. Each height sensor 3a and each depth sensor 3b emits a measured distance associated with an identifier making it possible to differentiate each sensor on the beam 3. The data from the sensors are received by the communication means 14 and transmitted to the calculation means 15. The calculation means 15 stores in memory each measurement received by associating it with the identifier of the corresponding sensor and at the time of reception determined depending on an internal clock. Such a clock is particularly understood in a software or hardware manner in the calculation means 15.

During a second step 102, the power supply means 13 are controlled by means of the communication means 14 so that the drive means 12 is powered. The beam is then set in motion. The start time of movement of the sensor beam 3 is determined as the time at which the power supply to the drive means 12 is controlled. In a particular embodiment, the acquisition of measurements of a current sensor configured so as to measure the power supply current of the drive means 12 is controlled, and the start time of movement of the sensor beam 3 is determined when the power supply current of the drive means 12 exceeds a predetermined current threshold. During a third step 103, it is determined whether the movement duration of the sensor beam 3 has elapsed. The movement duration of the beam is equal to the ratio of the length that can be travelled by the sensor beam 3 divided by the average speed of movement, determined by design or by tests and stored in the calculation means 15. When this is the case, the height sensors 3a are controlled so as to interrupt the acquisition thereof. Thus, the autonomy of the local battery 3c is extended.

During a fourth step 104, the available floor area and the available volume of the loading zone are determined by carrying out the following sub-steps.

During a sub-step 104a, from the measurements received, those whose date is comprised between the start date of movement of the beam and the end date of movement of the beam equal to the sum of the start date of movement of the beam and the movement duration of the beam is determined.

For each measurement of a height sensor 3a whose date is comprised between the start date of movement of the beam and the end date of movement of the beam, the longitudinal coordinate x is then defined as the distance between the position of the sensor during the measurement and the first side of the loading zone.

In a first embodiment, the longitudinal coordinate x is determined as being equal to the average moving speed of the beam 3 multiplied by the difference between the stored date and the start date of movement of the beam.

In another embodiment, the longitudinal coordinate x is determined as being equal to the sum of the depth measurement of the depth sensor directed towards the first side of the loading zone and the offset in the longitudinal direction x between the lens of the depth sensor 3b and the lens of the height sensor 3a having carried out the measurement.

In yet another embodiment, the longitudinal coordinate x is determined as being equal to the difference between the depth of the loading zone and the sum of the depth measurement and the offset in the longitudinal direction x between the lens of the depth sensor 3b directed towards the side opposite the first side of the loading zone and the lens of the height sensor 3a having carried out the measurement. The depth of the loading zone is defined as the distance between the first side of the loading zone and the opposite side. In a trailer, the distances between the sides of the loading zone and the walls of the trailer must be taken into account.

It should be noted that these embodiments are not exclusive and that the longitudinal coordinates determined according to one of the embodiments above measurements can be compared with each other to determine an erroneous value, particularly by a three-way voting mechanism. Additional robustness concerning the determination of the longitudinal coordinate x is thus conferred to the determination system 1.

The transverse coordinate y is defined as the distance between the height sensor whose measurement is being processed and the first height sensor 3a of the beam. This distance is known by design depending on the spacing of the height sensors 3a along the beam 3. By construction, the transverse coordinate y of the first sensor 3a of the beam is equal to zero. Nevertheless, other values of the transverse coordinate y of the first sensor can be chosen. These values must be taken into account in the calculation of the coordinates as an offset value.

The height coordinate z is defined as the difference between the height of the loading zone minus the height measurement of the height sensor 3a. In a particular embodiment, an absolute height coordinate z is determined by subtracting the distance between the lens or the aperture of the height sensor 3a and the height of the loading zone.

For packaged cargoes, the available floor area and the available volume are determined by carrying out the following sub-steps 104b to 104e.

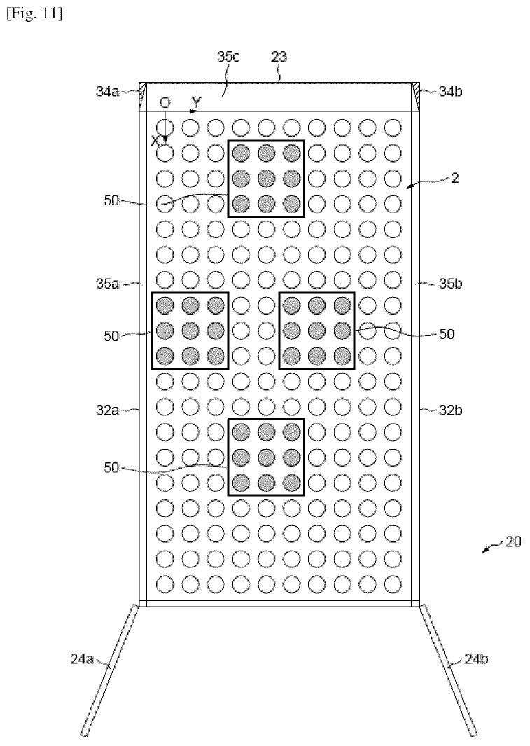

During a sub-step 104b, the points whose height coordinate z is less than a predetermined threshold are determined. In a preferred embodiment, the predetermined threshold is less than the thickness of a pallet. It is also possible to choose, for practicality, the lifting height defined above and generally equal to 10 cm. [FIG. 11] illustrates the mapping of the layout of cargoes 50 resulting from this determination for the layout illustrated previously in [FIG. 5]. Each disc represents the point of a height measurement by a height sensor 3a. It will be understood that the number and layout of these measurements is intended only to illustrate the description of the determination. Other numbers of measurements and other reasons for measurements are conceivable and form part of the scope of the invention.

In a particular embodiment, it is possible to take into account a minimum size of cargoes, greater than the pallet thickness or the lifting height. This is particularly the case when drums or containers are loaded in the loading zone. A different predetermined threshold can then be chosen.

In another embodiment, intermediate occupancy areas can be determined by comparing the z coordinates with a second predetermined threshold.

During a sub-step 104c, an elementary area is then associated with each point whose coordinate is less than the predetermined threshold. An elementary area is equal to the product of the distance between two height sensors 3a in the transverse direction y and the distance between two successive measurements in the longitudinal direction x.

During a sub-step 104d, the available floor area is determined by determining the number of points whose height coordinate z is less than the predetermined threshold and by multiplying this number by the elementary area.

During a sub-step 104e, the available volume is determined by multiplying the available floor area by the height of the loading zone.

It will be understood that at the end of these steps, the available floor area, the available volume and the distribution of cargoes in the loading zone are simultaneously available. It is then possible to optimise the placement of the cargoes after shape recognition on the free floor areas.

For bulk cargoes, the available volume is determined by carrying out the following sub-steps.

At the end of the sub-step 104a, the method continues with a sub-step 104f, during which the volume occupied by the cargo is determined by integrating the heights of each measurement along the longitudinal direction x and the transverse direction y.

The available volume is determined by subtracting the volume occupied by the cargo from the total volume of the loading zone.

The determination system and the control method have been described above in relation to a moving beam. It will be understood that the moving beam may have additional functions, such as the deployment or the removal of a removable cover. In some embodiments, the sensors and elements arranged on the moving beam are arranged on a removable cover hoop, preferably the first hoop of a removable cover. The removable cover hoop then forms a moving beam within the meaning of this description. The sensors then scan the loading zone when the removable cover is opened or closed.

Similarly, it will be understood from reading the above description that the processing means may be local, remote or distributed between local and remote means.

The determination system and the corresponding control method have been described and illustrated for measuring the free floor area of a loading zone, in particular in a truck trailer. Nevertheless, the invention comprises measuring the free floor area or free volume of a loading zone in absolute terms and in a truck without a trailer, in an aircraft, in a ship or in any vehicle equipped with a loading zone in which goods are deposited or removed.

The determination system and the control method can also be applied to buildings such as logistics centres or warehouses.

In addition, it will become clearly apparent from reading the above description that the determination of free floor area or free volume in the case of bulk cargoes is carried out totally autonomously without needing human intervention. The invention also comprises a determination system and control method applied to autonomous vehicles. For these applications, reference will be made particularly to the French patent application FR1759675 on behalf of the applicant describing the actuation of a removable cover depending on the GPS position of a vehicle. Reference will also be made to the patent application FR 1759676 also on behalf of the applicant describing the determination and the transmission of the occupied floor area and of the occupied volume in a vehicle and the rerouting thereof depending on the one hand on the data received and on the other hand on cargoes compatible with the position of the vehicle, the free floor area and/or the free volume.

1. System for determining a free floor area of a loading zone, the system comprising:
drive means;
communication means;
processing means; and a moving beam on which height sensors are arranged that are directed towards the floor of the loading zone according to a normal incidence and aligned with one another at a constant height from said floor, the moving beam being designed so as to extend in a first direction above the loading zone and being configured so as to move above the loading zone under the effect of the drive means in a second direction, the processing means being configured to determine at least the free floor area of the loading zone depending on a data received from the height sensors by means of communication means.

2. Determination system according to claim 1, wherein the moving beam is provided with at least one depth sensor, powered by a power supply means, and configured to determine a distance on the opposite side of the loading zone, the communication means comprise a connection to each depth sensor.

3. Determination system according to claim 2, wherein the communication means comprise a wireless connection with a local data storage means arranged on the moving beam and connected to the height sensors and, when present, to the depth sensor, so as to transmit data acquired by the sensors when the moving beam has completed scanning the loading zone.

4. Determination system according to claim 3, wherein the height sensors and the depth sensor are small aperture angle distance sensors.

5. Determination system according to claim 1, wherein the drive means comprise at least first and second ropes each running along an end pulley, towards a tension pulley by means of an angle return pulley, the second rope being crossed by means of an intermediate pulley, the first and second ropes being set in motion by means of a drive roller driven by a rotation by a drive means.

6. Determination system according to claim 1, provided with power supply means comprising a battery supplying power to the drive means, the communication means and the processing means, a local battery arranged on the moving beam and a contactless power transmission system configured to recharge the local battery of the moving beam, the local battery being configured to supply power to the height sensors and depth sensors when the determination system is provided with the local battery.

7. Determination system according to claim 1, wherein the loading zone is located in a truck, in a truck bed, in a truck trailer, in a ship, in a railway car, in an aircraft, or in a building.

8. Method for controlling a determination system according to claim 1, the method comprising:
Controlling the height sensors so as to acquire measurements,
Dating each measurement received according to an internal clock,
Controlling the drive means so that the beam starts to move and storing a start time of movement of the beam,
Determining among the received measurements, those whose date is between a start date of movement of the beam and a end date of movement of the beam equal to a sum of the start date of movement of the beam and a duration of movement of the beam,
For each measurement of a height sensor, defining a longitudinal coordinate as the longitudinal position of the sensor at the time of the measurement, defining a transverse coordinate as a distance between the height sensor whose measurement is processed and a first height sensor of the beam and defining the height coordinate as a difference between a ceiling height of a trailer minus the height measurement of the height sensor,
Determining the free floor area in the loading zone and at least one of an free volume in the loading zone, an occupied floor area in the loading zone, an occupied volume in the loading zone, a mapping of the free floor area as an image depending on points of which the height coordinate is less than a predetermined threshold, or a mapping of the occupied floor area as an image depending on points of which the height coordinate is greater than said predetermined threshold.

9. Control method according to claim 8, wherein the longitudinal position of a sensor at a stored date is determined as an average moving speed of the beam multiplied by the difference between the stored date and the start date of movement of the beam.

10. Control method according to claim 8, wherein at least one depth sensor is controlled so as to acquire measurements and the longitudinal position of a sensor is determined depending on a distance measurement of a first depth sensor directed towards a side of the loading zone normal to the direction of movement of the moving beam.

11. Control method according to claim 8, wherein the start time of movement of the sensor beam is determined as the time at which a power supply means are controlled in order to power the drive means.

12. Control method according to claim 8, wherein measurement acquisition of a current sensor configured so as to measure a power supply current of the drive means is controlled, and the start time of movement of the sensor beam is determined when the power supply current of the drive means exceeds a predetermined current threshold.

13. Control method according to claim 8, wherein, for packaged cargoes,
Associating an elementary area with each point whose height coordinate is less than the predetermined threshold, the elementary area being equal to a product of the distance between two height sensors in a first direction normal to a movement of the moving beam and the distance between two successive measurements in a second direction colinear to the movement of the moving beam, then
Determining an available floor area by adding up the elementary areas, and
Determining an available volume by multiplying the available floor area by the height of the loading zone.

14. Control method according to claim 13, wherein, for packaged cargoes,
Determining an elementary area including a plurality of measurement points, averaging measurements over each elementary area, determining the elementary areas for which an average height coordinate is less than the predetermined threshold, then
Determining the available floor area by adding up the elementary areas for which the average height coordinate is less than the predetermined threshold, and
Determining an available volume by multiplying the available floor area by the height of the loading zone.

15. Control method according to claim 8, wherein the predetermined threshold is defined as being less than a minimum size of the cargoes.

16. Control method according to claim 14, wherein, for bulk cargoes, the available volume can be determined as the volume of the loading zone minus the volume occupied by the determined cargo by integrating the height sensor measurements in the first direction and in the second direction.

17. Control method according to claim 8, wherein an occupied floor area or an occupied volume are determined depending on measurement points whose height coordinate is greater than the predetermined threshold.
